(19) United States
(12) Patent Application Publication
(10) Pub. No.: US 2018/0304407 A1
(43) Pub. Date: Oct. 25, 2018

(54) BUILD-UP WELDING OF SUPERIMPOSED APPLIED COATING LAYERS HAVING DIFFERENT THICKNESSES

(71) Applicants: Siemens Aktiengesellschaft, München (DE); Fraunhofer Gesellschaft zur Förderung der angewandten Forschung e.V., München (DE)

(72) Inventors: Nikolai Arjakine, Berlin (DE); Georg Bostanjoglo, Berlin (DE); Bernd Burbaum, Falkensee (DE); Andres Gasser, Aachen (DE); Stefanie Linnenbrink, Kreuzau (DE); Frank Mentzel, Aachen (DE); Michael Ott, Mülheim an der Ruhr (DE); Norbert Pirch, Aachen (DE)

(21) Appl. No.: 15/767,781

(22) PCT Filed: Jun. 21, 2016
(86) PCT No.: PCT/EP2016/064297

§ 371 Date: Apr. 12, 2018

(30) Foreign Application Priority Data
Nov. 6, 2015 (DE) 10 2015 221 889.9

(51) Int. Cl. B23K 26/342; B23K 26/144

(52) U.S. Cl. CPC B23K 26/342; B23K 26/144

(57) ABSTRACT

A method and component of coating layers having different thicknesses are produced by the variation of the powder mass flow, whereby the microstructure of the entire build-up welded area is adjusted in a targeted and an advantageous manner is provided.

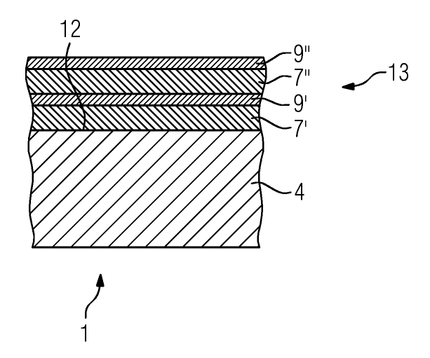

### CROSS-REFERENCE TO RELATED APPLICATIONS

This application claims priority to PCT Application No. PCT/EP2016/064297, having a filing date of Jun. 21, 2016, based off of German application No. 102015221889.9 having a filing date of Nov. 6, 2015, the entire contents of both of which are hereby incorporated by reference.

### FIELD OF TECHNOLOGY

The following relates in particular to laser build-up welding with a powder auxiliary material using an oscillating movement (wobble strategy). By means of the wobble strategy during the laser build-up welding, it is possible for nucleation and grain growth in the mushy zone (pasty zone) to be influenced in targeted fashion, such that the growth of a columnar solidification front is suppressed or avoided entirely. Experimental results show a virtually crack-free microstructure in the nickel-based superalloys IN738.

### BACKGROUND

In the past there has been difficulty with crack-free microstructures.

### SUMMARY

An aspect relates to realizing a crack-free microstructure.

There is an evident dependency of the solidified microstructure on the powder mass flow. In the case of large powder mass flows, the result is a fine-grain microstructure, wherein the grain size is considerably smaller than the layer height. If the powder mass flow is reduced, then beyond a threshold, crystallization of rod-crystalline grains of approximately the size of the layer height occurs.

### BRIEF DESCRIPTION

Some of the embodiments will be described in detail, with reference to the following FIGURE, wherein like designations denote like members, wherein:

The FIGURE and the description present merely exemplary embodiments of the invention.

### DETAILED DESCRIPTION

It is proposed that a desired microstructure be set through the adaptation of the powder mass flow. In the case of a layered construction, it is thus possible to realize different microstructures in each layer. In this way, the mechanical characteristics can be influenced in targeted fashion. Furthermore, at locations which are critical with regard to hot cracking, it is possible in targeted fashion to set a very fine-grained microstructure. The risk of crack formation is thus reduced.

The advantage lies in improved material characteristics of the component in relation to conventionally welded components.

The FIGURE shows a component 1 with a substrate 4 and with a build-up welded region 13 (material build-up).

The component 1 had at least one crack or defect which has been removed, such that, for the re-use of the component, material must be newly applied, or a new component is built up in hybrid fashion.

The substrate 4 of the component 1 is preferably a nickel-based or cobalt-based superalloy.

Material is applied to the surface 12 of the substrate 4 to be treated.

This is realized in particular by means of a powder build-up welding process, in particular by means of a laser powder build-up welding process.

The different layer thicknesses of the build-up layers 7′, 9′, 7″, 9″, . . . for the material build-up are realized through adjustment of the powder mass flow.

Build-up layers of different thickness are provided or are generated, that is to say thick build-up layers 7′, 7″, . . . and thin build-up layers 9′, 9″, . . . are present. The difference in thickness between the directly successive thick build-up layers 7′, 7″, . . . and thin build-up layers 9′, 9″, . . . amounts to at least 20% (relative).

The sequence of relatively thin 9′, 9″ and relatively thick 7′, 7″ build-up layers may be varied as desired, that is to say with either the thin build-up layer 9′ first or the thick build-up layer 7′ first.

It is likewise possible for the thick build-up layers 7′, 7″, . . . to also be formed with different thicknesses, but these remain at least 20% thicker than the thickest build-up layer of the thin build-up layers 9′, 9″, . . . .

A similar situation applies to the thin build-up layers 9′, 9″.

The FIGURE illustrates merely one example of the invention, in which the sequence of the relatively thin 9′, 9″, . . . and relatively thick 7′, 7″, . . . build-up layers is an alternating sequence.

The material for the thick and thin build-up layers is preferably the same.

It is likewise possible for the material composition of the thick 7′, 7″ and thin 9′, 9″ build-up layers to be varied, alternated or graduated, wherein the following examples do not constitute a limitation:
7′ Material 1
9′ Material 2
7″ Material 1
9″ Material 2
or
7′ Material 1
9′ Material 1
7″ Material 2
9″ Material 2
or
7′ Material 1
9′ Material 1
7″ Material 1
9″ Material 2
7′″ Material 2
9′″ Material 2
or
7′ Material 1
9′ Material 2
7″ Material 2
9″ Material 2
7′″ Material 1
9′″ Material 2
or . . . .

Material 1 and material 2 differ by at least 20% with regard to one alloy constituent, or have at least one alloy element more or fewer.

It is possible for at least 4, in particular at least 8, very particularly at least 12 build-up layers to be provided.

The laser parameters are optionally adapted to a smaller or larger powder mass flow: If an upper threshold of the powder mass flow is overshot, then fusion defects, that is to say holes, occur. If the lower threshold is undershot, then the grains grow across multiple layers.

That is to say, if it is sought to realize even greater thicknesses of the build-up layers, without fusion defects, than those possible in the stated parameter window, then the power must also be increased. This is analogous for relatively small thicknesses, without the grains growing across multiple layers. Here, the power must then be reduced.

In particular, with the wobble strategy, the grain sizes within a layer can be set within certain limits.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method for material build-up on a surface of a substrate in which method multiple build-up layers are applied, which are formed with different thicknesses, wherein different thicknesses means that a difference in thickness between at least two of the respective directly successive build-up layers amounts to at least 20%, wherein the different thickness is produced by adjusting the powder mass flow.

2. The method as claimed in claim 1, in which the parameters for a build-up process for the different powder mass flows of the build-up layers are adapted.

3. The method as claimed in claim 1, in which a build-up welding process is used, wherein the build-up welding process is a laser powder build-up welding process.

4. The method as claimed in claim 1, in which a wobble technology is implemented.

5. The method as claimed in claim 1, in which build-up welding is performed on a nickel-based or cobalt-based substrate.

6. A component, produced by the method as claimed in claim 1, in the case of which component a build-up weld has build-up layers of different thickness.

7. The methods as claimed in claim 1, which has at least 4 build-up layers.

8. The method as claimed in claim 1, in which the material for the build-up layers are altered.

9. The method as claimed in claim 1, in which the thin build-up layers have a first material and the thick build-up layers have a second material.

10. The method as claimed in claim 1, in which the material of the thick and thin build-up layers are the same.
